(19) United States
(12) Patent Application Publication
(10) Pub. No.: US 2012/0093969 A1
(43) Pub. Date: Apr. 19, 2012

(54) BIRDSEED FORMULATIONS FOR ATTRACTING DESIRABLE BIRDS FROM THE MIDWESTERN REGION OF THE UNITED STATES

(76) Inventor: Mario Olmos, Fort Worth, TX (US)

(21) Appl. No.: 13/083,523

(22) Filed: Apr. 8, 2011

Related U.S. Application Data
(60) Provisional application No. 61/322,147, filed on Apr. 8, 2010.

(51) Int. Cl. A23K 1/18

(52) U.S. Cl. 426/1

(57) ABSTRACT

Birdseed blends are formulated to attract desirable birds that generally reside in the Midwestern Region and other similar regions of the United States. Such birdseed formulations may attract more birds than conventional black oil sunflower seeds alone or conventional birdseed mixes. In addition, such birdseed formulations also may generally attract more desirable birds than black oil sunflower seeds or conventional birdseed mixes, while attracting less undesirable birds.

### CROSS REFERENCE TO RELATED APPLICATION

This application claims the benefit under 35 U.S.C. §119(e) to U.S. Provisional Application No. 61/322,147, filed on Apr. 8, 2010, entitled “Systems of Attracting Desired Birds from the Midwestern Region,” which is incorporated by reference in its entirety.

### FIELD OF THE INVENTION

The disclosure relates generally to birdseed formulations, and in particular, to birdseed formulations for attracting desirable birds from the Midwestern Region of the United States and other similar regions.

### BACKGROUND

Conventional birdseed mixes generally provide a food source for and attract different types of birds. Such birdseed mixes, however, can also attract unwanted birds and animals such as, for example, grackles, blackbirds, starlings, and squirrels.

### SUMMARY

Embodiments of the present disclosure provide birdseed formulations that attract desirable birds in the Midwestern Region of the United States. Such formulations may comprise black oil sunflower, thistle, red millet, white safflower, white millet, and sunflower chips. Black oil sunflower may comprise 5-15% of the resultant formulation. The resultant formation also may be comprised of 5-15% thistle, 15-25% red millet, 5-15% white safflower, 2-8% white millet, and 40-50% sunflower chips. Desirable birds may include finches, cardinals, chickadees, sparrows, orioles, woodpeckers, songbirds, and colorful or passerine birds. Birdseed formulations according to embodiments of the present disclosure attract more desirable birds than black oil sunflower seeds.

Other embodiments of the present disclosure provide birdseed formulations that attract desirable birds in the Midwestern Region of the United States. Such formulations may be comprised of 5-15% black oil sunflower, 5-15% thistle, 15-25% red millet, 5-15% white safflower, 2-8% white millet, and 40-50% sunflower chips. Birdseed formulations according to embodiments of the present disclosure attract more desirable birds than black oil sunflower seeds.

Additional embodiments of the present disclosure may provide birdseed formulations that may attract desirable birds in the Midwestern Region of the United States. Such formulations may be comprised of approximately 10% black oil sunflower, approximately 10% thistle, approximately 20% red millet, approximately 10% white safflower, approximately 5% white millet, and approximately 45% sunflower chips. Birdseed formulations according to embodiments of the present disclosure attract more desirable birds than black oil sunflower seeds. The presence of red millet in birdseed formulations according to embodiments of the present disclosure may provide color contrast in such formulations that may attract desirable birds.

### BRIEF DESCRIPTION OF THE DRAWINGS

For a more complete understanding of this disclosure and its features, reference is now made to the following description, taken in conjunction with the accompanying drawings, in which:

FIG. 1 depicts a somewhat simplified illustration of a field test area that may be used to test birdseed formulations according to embodiments of the present disclosure against control birdseeds;

FIG. 2 depicts boxplots comparing the total number of birds expressing a preference for birdseed formulations according to embodiments of the present disclosure as compared to a black oil sunflower (BOS) control;

FIG. 3 depicts boxplots for the total number of desirable birds expressing a preference for birdseed formulations according to embodiments of the present disclosure as compared to a BOS control;

FIG. 4 depicts boxplots comparing the total number of birds expressing a preference for birdseed formulations according to embodiments of the present disclosure as compared to a Kaytee Birders' Blend (KBB) control; and

FIG. 5 depicts boxplots for the total number of desirable birds expressing a preference for birdseed formulations according to embodiments of the present disclosure as compared to a KBB control.

### DETAILED DESCRIPTION

Embodiments of the present disclosure generally provide birdseed formulations for attracting desirable birds from the Midwestern Region of the United States and other similar regions. Such birdseed formulations may include customized birdseed mixes designed to attract, for example, desirable birds that generally reside in the Midwestern Region of the United States.

In an embodiment of the present disclosure, a birdseed formulation may be provided that attracts more birds than black oil sunflower seeds alone or other conventional birdseed mixes. In another embodiment of the present disclosure, a birdseed formulation may be provided that attracts more desirable birds than black oil sunflower seeds or other conventional bird food mixes. Birdseed formulations according to embodiments of the present disclosure also may attract and provide balanced nutrition for colorful songbirds or other desirable birds including, but not necessarily limited to, finches, cardinals, chickadees, sparrows, orioles, woodpeckers, songbirds, and other colorful or passerine birds that may be generally found in the Midwestern Region of the United States.

In a further embodiment of the present disclosure, birdseed formulations may be provided that may attract less undesirable birds than black oil sunflower seeds or other conventional bird food mixes. Undesirable birds may include, but are not necessarily limited to, grackles, cowbirds, and blackbirds.

Birdseed formulations according to embodiments of the present disclosure may include, but are not necessarily limited to, black oil sunflower, thistle, red millet, white safflower, white millet, and sunflower chips. It should be appreciated that different percentages of each component of these birdseed formulations may be incorporated within the ranges specified below without departing from the present disclosure. The various components comprising birdseed formulations according to embodiments of the present disclosure may now be described.

Embodiments of the present disclosure may provide birdseed formulations that may be generally comprised of 5-15% black oil sunflower (more preferably approximately 10%). Black oil sunflower is generally a black-colored seed provides high quality protein and fat nutrition for many birds. Birds generally are drawn to birdseed formulations containing black oil sunflower; however, it should be appreciated that undesirable birds are generally more drawn to black oil sunflower than more desirable birds.

Birdseed formulations according to embodiments of the present disclosure also may include thistle (also referred to as nyjer). Thistle is a generally black-colored, rice-shaped seed having relatively high fat and protein content. Thistle also may include vitamins, such as Vitamin A, as well as a relatively high concentration of lutein, a natural pigment that may be used to synthesize yellow and red pigments. Thistle may generally comprise 5-15% (more preferably approximately 10%) of the resultant birdseed formulation according to embodiments of the present disclosure. The presence of thistle in these birdseed formulations may tend to attract more desirable birds.

Birdseed formulations according to embodiments of the present disclosure also may include red millet, a generally orange-red seed having relatively good fat content. Red millet generally provides color contrast in birdseed formulations according to embodiments of the present disclosure, and this may have a tendency to attract more desirable birds. Embodiments of the present disclosure may be comprised of 15-25% red millet (more preferably approximately 20%).

White safflower also may be incorporated into birdseed formulations according to embodiments of the present disclosure. White safflower is a generally white or ivory-colored seed having a husk. It may be an attractant for desirable birds, such as cardinals, according to embodiments of the present disclosure. Birdseed formulations according to embodiments of the present disclosure may be comprised of 5-15% (more preferably approximately 10%) white safflower.

Birdseed formulations according to embodiments of the present disclosure also may include white millet, a generally white, marble-colored seed having relatively high fat content. White millet may have a tendency to attract desirable birds, such as finches, chickadees, buntins, and sparrows. Embodiments of the present disclosure may be comprised of 2-8% white millet (more preferably approximately 5%).

Sunflower chips may be incorporated into birdseed formulations according to embodiments of the present disclosure. Sunflower chips generally have a striped gray and black color. Various sizes of sunflower chips, including small, medium, and large, and combinations thereof, may be incorporated into these birdseed formulations without departing from the present disclosure. While birds may prefer sunflower chips, it should be appreciated that sunflower chips also may have a tendency to attract unwanted animals, such as squirrels. Accordingly, while sunflower chips may be incorporated into birdseed formulations, it may be desirable to limit the amount of sunflower chips to minimize feeding by unwanted animals. However, sunflower chips may be of benefit as a filler seed in such birdseed formulations. Embodiments of the present disclosure may be comprised of 40-50% sunflower chips (more preferably approximately 45%).

It should be appreciated that other seeds or components may be included in birdseed formulations according to embodiments of the present disclosure. Further, the composition of birdseed formulations according to embodiments of the present disclosure may vary depending on the composition, color, and/or seed-size that may be desired.

In order to evaluate the effectiveness of birdseed formulations according to embodiments of the present disclosure, various trials were conducted. These trials evaluated whether birds express a preference for birdseed formulations according to embodiments of the present disclosure as compared to several conventional (or control) birdseed offerings.

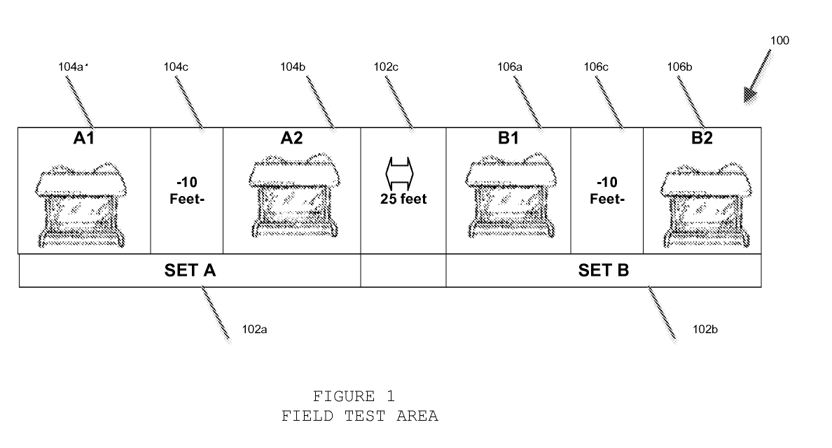

FIG. 1 depicts a somewhat simplified illustration of field test area 100 that may be used to evaluate preference for birdseed formulations according to embodiments of the present disclosure compared to birdseed controls. It should be appreciated that field test area 100 shown in FIG. 1 is for illustrative purposes only and that any other suitable test or system could be used in conjunction with, or in lieu of, field test area 100 without departing from the present disclosure.

In one test scenario, field test area 100 may include test set area “A” 102a, test set area “B” 102b and separation area 102c located in the Midwestern Region of the United States, or another similar region. Test set area “A” 102a and test set area “B” 102b may be positioned about 25 feet away from each other. Test set area “A” 102a and test set area “B” 102b may generally have similarities in environment, vegetation, sun/shade levels, noise levels, topography, human contact, water access, disturbance from other animals, the presence of natural predators, cover from environment, wind, trees, branches, vegetation, wildlife, other environmental factors, or any suitable combination thereof.

In one test scenario, test set area “A” 102a may include two bird feeders 104a and 104b positioned about 10 feet from one another. Similarly, test set area “B” 102b may include two bird feeders 106a and 106b positioned about ten feet from each other. Bird feeders 104a and 104b may include any suitable shape, size, or configuration of bird feeders. In an embodiment of the present disclosure, bird feeders 106a and 106b may be similar to or identical to bird feeders 104a and 104b.

In test set area “A” 102a, bird feeders 104a and 104b may contain a birdseed formulation according to embodiments of the present disclosure in one testing round, and a control birdseed in a second testing round. In an embodiment of the present disclosure, a first testing round may be performed over a period of four days and a second testing round may commence shortly thereafter.

A control birdseed, as referred to herein, may be any suitable conventional birdseed available in, for example, the Midwestern Region of the United States. A control formula may be comprised of black oil sunflower seed (BOS) alone or other conventional birdseed blends, such as Kaytee Birders' Blend (KBB).

Data from a first round of testing may be collected by observing the type or number of each bird species that visits test set area “A” 102a during a predetermined testing period. In an embodiment of the present disclosure, in one testing scenario, data may be collected and recorded, and any subsequent data collection may occur after five minutes has elapsed for both test set area “A” 102a and test set area “B” 102b. The data collection may be repeated until, for example, thirty minutes has elapsed. After a break of about fifteen minutes, another testing period of approximately thirty minutes may be repeated, for example, once a day for four days.

The test procedures may include testing of a birdseed formulation according to embodiments of the present disclosure (KMWSB) against a control (BOS or KBB) in both test areas, test set area “A” 102a and test set area “B” 102b. At any given time, both the KMWSB formula and the control may be tested in at least two of bird feeders 106a and 106b and bird feeders 104a and 104b to ensure uniform evaluation of the various birdseeds.

In embodiments of the present disclosure, data collected using uniform testing procedures described above may include tracking the number of desirable birds, undesirable birds, unique species of birds, and/or all birds visiting, for example, each of bird feeders 106a and 106b and bird feeders 104a and 104b shown in FIG. 1 at various intervals as described above. Testing may be repeated any suitable number of times and for any suitable number of trials.

The data collected may be evaluated using a winner-loser analysis where, for example, the total number of birds and/or species visiting a particular birdseed formulation may be compared between the same test set area “A” 102a and test set area “B” 102b. Winner-loser analysis generally summarizes the number of times desirable birds and total numbers of birds visiting feeders during various experiments preferred birdseed formulations according to embodiments of the present disclosure compared to a control. Evaluations of the total number of birds attracted to each formulation as well as the total number of desirable birds attracted to each formulation also may be made.

Birdseed formulations according to embodiments of the present disclosure (KMWSB) were compared with a control formula of black oil sunflower seed (BOS) in 60 experiments using a field test scenario as depicted in FIG. 1. In winner-loser analysis comparing the total number of birds who preferred KMWSB versus the BOS control, KMWSB was preferred in 43 out of 60 tests and 2 draws were observed. The BOS control was preferred in 15 of the tests. In a comparison of the total number of birds attracted to KMWSB versus the BOS control, over the same 60 experiments, more birds preferred KMWSB over the BOS control.

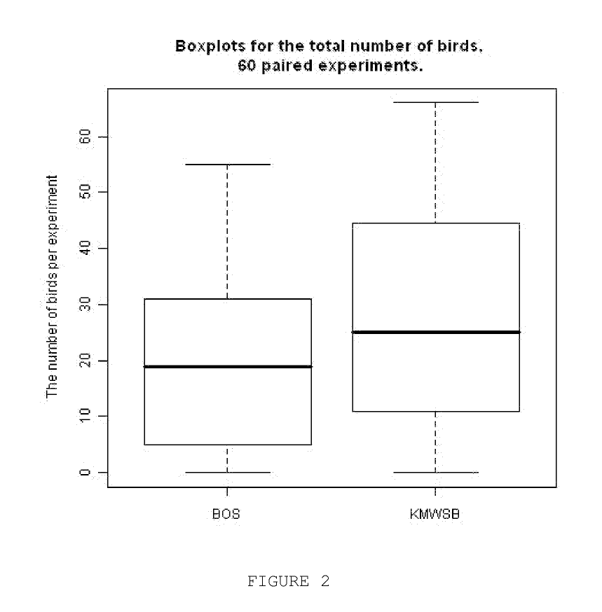

FIG. 2 depicts boxplots for the total number of birds attracted to KMWSB versus the BOS control. In any given experiment, the maximum number of birds expressing a preference for KMWSB was 66, while the maximum number of birds expressing a preference for the BOS control was 55. The median number of birds who expressed a preference for KMWSB was 25.00, and the mean number who expressed a preference for KMWSB was 28.12, as depicted in FIG. 2. In contrast, the median number of birds expressing a preference for the BOS control was 19.00, and the mean number who expressed a preference for the BOS control was only 19.70, also as depicted in FIG. 2.

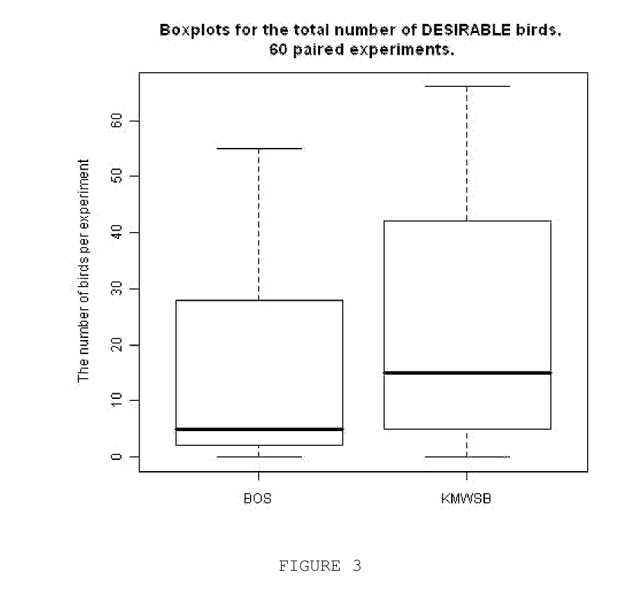

FIG. 3 depicts a comparison of the total number of desirable birds who expressed a preference for KMWSB or the BOS control over the same 60 paired experiments. The median number of desirable birds who expressed a preference for KMWSB was 15.00, and the mean number who expressed a preference for KMWSB was 23.03. In contrast, the median number expressing a preference for the BOS control was only 5.00, with a mean number who expressed a preference for the BOS control of 13.77. Winner-loser analysis also was used to evaluate the total number of desirable birds who expressed a preference for KMWSB or the BOS control. Out of the 60 experiments that were conducted comparing KMWSB to the BOS control, KMWSB was preferred over the BOS control in 49 experiments, the BOS control was preferred over KMWSB in 9 experiments, and a draw was observed in 2 experiments.

Birdseed formulations prepared according to embodiments of the present disclosure (KMWSB) also were compared to a conventional birdseed blend (Kaytee Birders' Blend or KBB) in 60 experiments using a field test scenario as depicted in FIG. 1. In winner-loser analysis comparing the total number of birds who preferred KMWSB versus the KBB control, KMWSB was preferred in 47 out of 60 tests, the KBB control was preferred 13 times, and no draws were observed. In a comparison of the total number of birds attracted to KMWSB versus the KBB control over the same 60 experiments, more birds preferred KMWSB over the KBB control.

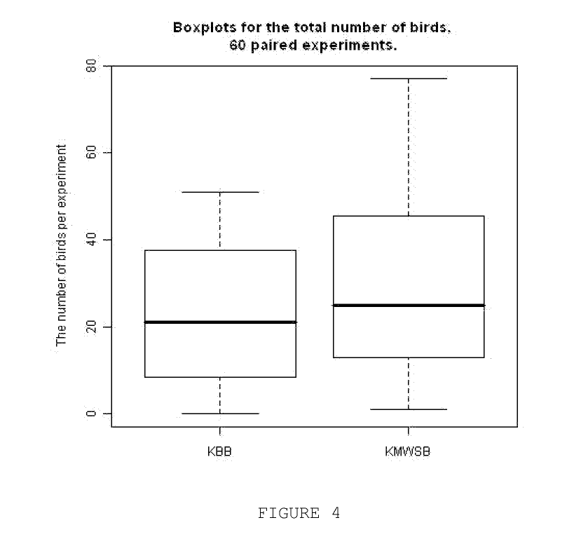

FIG. 4 depicts boxplots for the total number of birds attracted to KMWSB versus the KBB control. In any given experiment, the maximum number of birds expressing a preference for KMWSB was 77, while the maximum number of birds expressing a preference for the KBB control was 51. The median number of birds who expressed a preference for KMWSB was 25.00, and the mean number who expressed a preference for KMWSB was 29.07, as depicted in FIG. 4. However, the median number of birds expressing a preference for the KBB control was 21.00, and the mean number who expressed a preference for the KBB control was only 22.25, also as depicted in FIG. 4.

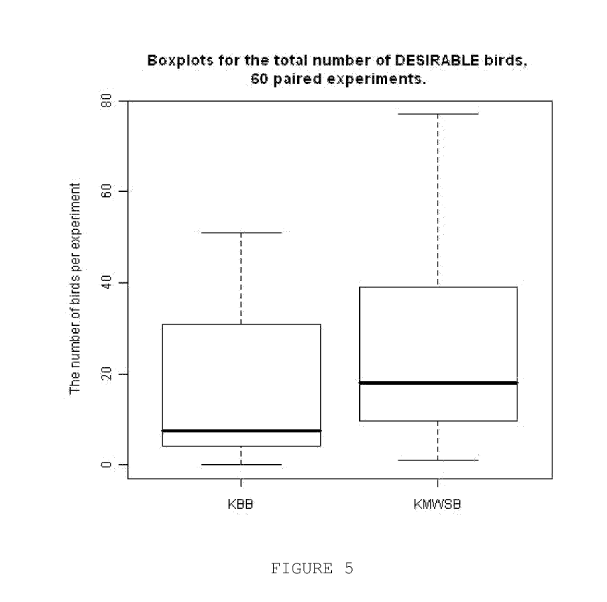

FIG. 5 depicts a comparison of the total number of desirable birds who expressed a preference for KMWSB or the KBB control over the same 60 paired experiments. The median number of desirable birds who expressed a preference for KMWSB was 18.00, and the mean number who expressed a preference for KMWSB was 24.98. In contrast, the median number who expressed a preference for the KBB control was only 7.50, with a mean number who expressed a preference for the KBB control of 16.67. Winner-loser analysis also was used to evaluate the total number of desirable birds who expressed a preference for KMWSB versus the KBB control. Out of the 60 experiments that were conducted comparing KMWSB to the KBB control, KMWSB was preferred over the KBB control in 46 experiments, the BOS control was preferred in 11 experiments, and 3 draws were observed.

Based on the various experiments conducted, birdseed formulations according to embodiments of the present disclosure, such as KMWSB, attract more desirable birds than the birdseed control. In other words, the number of desirable birds attracted to birdseed formulations according to embodiments of the present disclosure was higher than the birdseed controls. Further, birdseed formulations according to embodiments of the present disclosure, such as KMWSB, generally attracted more birds overall than the birdseed controls.

Although the present disclosure has been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A birdseed formulation that attracts desirable birds in the Midwestern Region of the United States, said formulation comprising:
black oil sunflower, thistle, red millet, white safflower, white millet, and sunflower chips.

2. The birdseed formulation of claim 1, wherein said formulation comprises 5-5% black oil sunflower.

3. The birdseed formulation of claim 1, wherein said formulation comprises 5-15% thistle.

4. The birdseed formulation of claim 1, wherein said formulation comprises 15-25% red millet.

5. The birdseed formulation of claim 1, wherein said formulation comprises 5-15% white safflower.

6. The birdseed formulation of claim 1, wherein said formulation comprises 2-8% white millet.

7. The birdseed formulation of claim 1, wherein said formulation comprises 40-50% sunflower chips.

8. The birdseed formulation of claim 1, wherein said desirable birds are selected from the group comprising:
finches, cardinals, chickadees, sparrows, orioles, woodpeckers, songbirds, and colorful or passerine birds.

9. The birdseed formulation of claim 1, wherein said formulation attracts more desirable birds than black oil sunflower seeds.

10. A birdseed formulation that attracts desirable birds in the Midwestern Region of the United States, said formulation comprising:
5-15% black oil sunflower;
5-15% thistle;
15-25% red millet;
5-15% white safflower;
2-8% white millet; and
40-50% sunflower chips.

11. The birdseed formulation of claim 10, wherein said formulation attracts more desirable birds than black oil sunflower seeds.

12. A birdseed formulation that attracts desirable birds in the Midwestern Region of the United States, said formulation comprising:
approximately 10% black oil sunflower;
approximately 10% thistle;
approximately 20% red millet;
approximately 10% white safflower;
approximately 5% white millet; and
approximately 45% sunflower chips.

13. The birdseed formulation of claim 12, wherein said formulation attracts more desirable birds than black oil sunflower seeds.

14. The birdseed formulation of claim 12, wherein said red millet provides color contrast in said formulation that attracts desirable birds.
